(19) United States
(12) Patent Application Publication
(10) Pub. No.: US 2004/0035263 A1
(43) Pub. Date: Feb. 26, 2004

(54) Handle of a wrench

(76) Inventor: Chih-Ching Hsien, Taichung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/224,512

(22) Filed: Aug. 21, 2002

(51) Int. Cl. B25B 13/16

(52) U.S. Cl. 81/170

(57) ABSTRACT

A wrench includes a function end and a handle is connected to the function end. The handle has a concave first side and a second side of the handle has two curvatures. The two curvatures have opposite slopes so that the two hands may hold the second side of the handle to exert a large force to rotate the handle.

### FIELD OF THE INVENTION

The present invention relates to a handle of a wrench and includes a single curvature in one side of the handle and two curvatures in opposite slopes in the other side of the handle. The handle is conveniently held when rotating.

### BACKGROUND OF THE INVENTION

A conventional wrench includes a function end and a handle which generally is a straight bar that is made of stiff material so that when loosening or tightening a nut, the user holds the handle and rotates the handle so that the nut securely engaged with the function end can be rotated with the rotation of the function end. In some situations, the nut is firmly tightened or is rusted so that the user has to exert a large torque to loosen the nut, two hands are required to hold the handle to rotate. The straight handle does not provide better grasp feature for the user to rotate because the width of the handle is the same and limited so that there are no proper points of exerting force for the two hands.

The present invention intends to provide a handle of a wrench and the handle has a concave first side and two curvatures defined in the other side of the handle so that the user may hold the second side of the handle by two hands comfortably and conveniently.

### SUMMARY OF THE INVENTION

In accordance with one aspect of the present invention, there is provided a wrench comprising a function end and a handle which is connected to the function end. The handle has a concave first side and two curvatures are defined in a second side of the handle. The two curvatures have opposite slopes.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows two hands are holding the second side of the handle of the wrench of the present invention;

FIG. 2 shows the handle of the wrench of the present invention is held by one hand;

FIG. 3 shows the fixed jaw and the movable jaw of the present invention are tapered at the front end thereof, and

FIG. 4 shows that the fixed jaw has a rounded root portion and the movable jaw has a rounded edge.

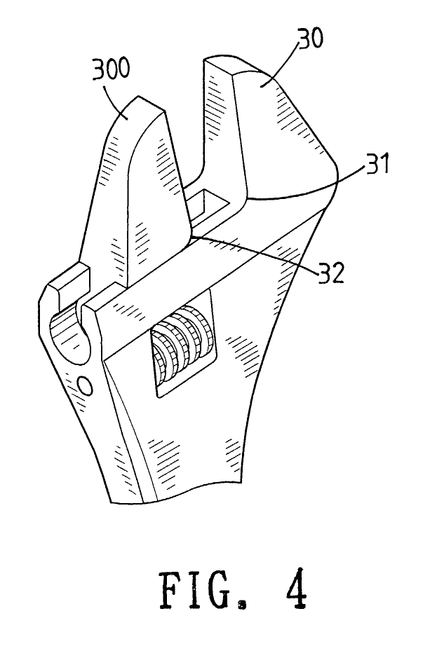

### DETAILED DESCRIPTION OF THE PREFERRED EMBODIMENT

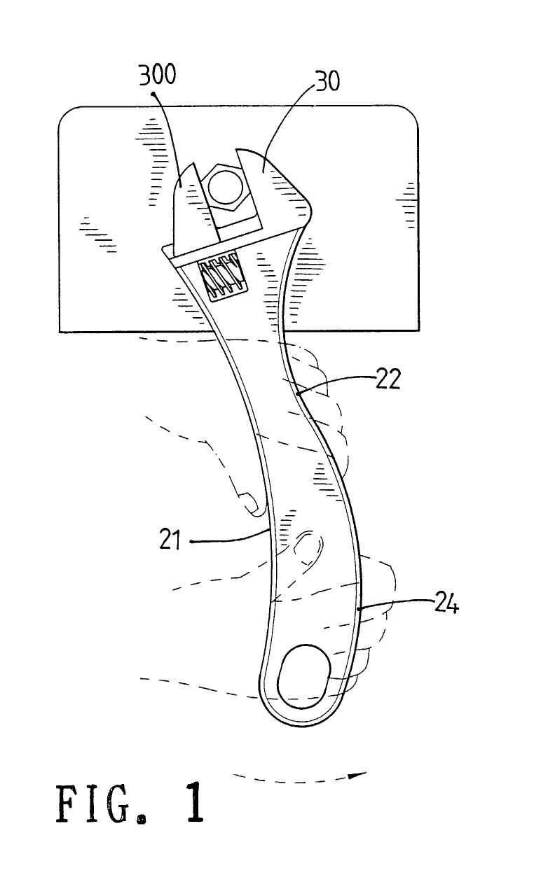

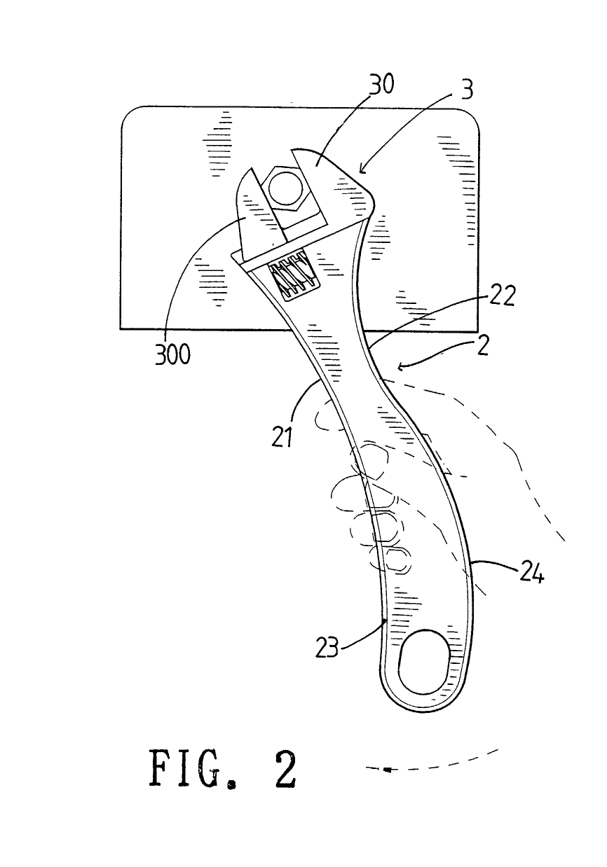

Referring to FIGS. 1 and 2, the wrench 1 of the present invention comprises a function end 3 comprising a fixed jaw 30 and a movable jaw 300, and a handle 2 which is connected to the function end 3. The handle 2 has a concave first side 21 and two curvatures 22, 24 are defined in a second side of the handle 2. The two curvatures 22, 24 have opposite slopes, in other words, the second side of the handle 2 has a protrusion portion and a concave portion. The concave portion of the second side is located close to the function 3.

The fixed jaw 30 includes a clamping surface which is used to clamp a side of an object such as a nut, and extends from the function end 3. A rounded root portion 31 is connected between the clamping surface and the function end 3. The movable jaw 300 has a clamping surface which faces the clamping surface of the fixed jaw 30 and includes a rounded edge 32 which faces the rounded root portion 31 of the fixed jaw 30. The rounded root portion 31 and the rounded edge 32 effectively reinforce the structural strength of the two jaws 30 and 300.

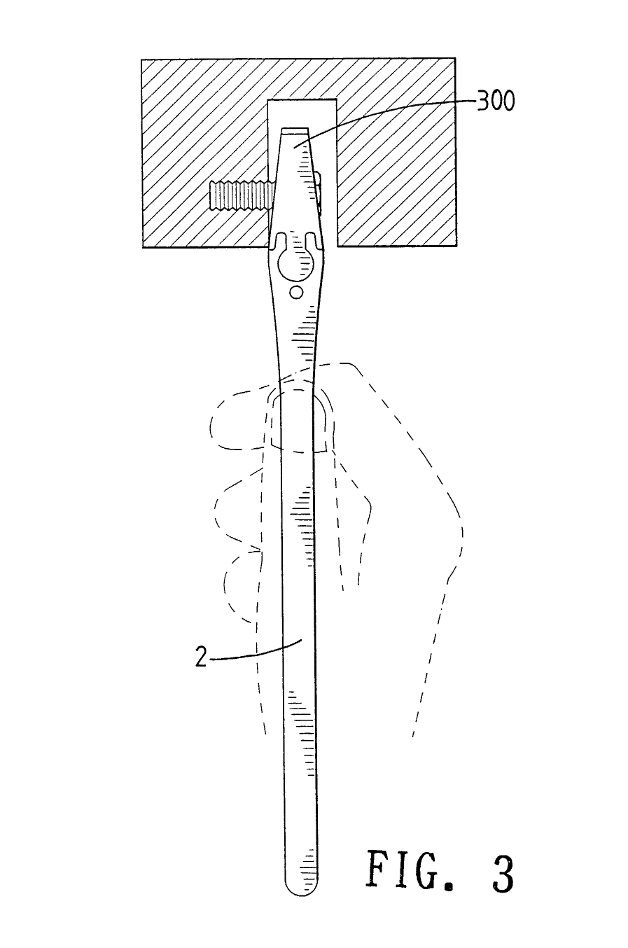

Referring to FIG. 3, each of the fixed jaw 230 and the movable jaw 300 are tapered at the front end thereof so that the function end 3 can be inserted into a narrow space to clamp the object.

FIG. 1 shows that two hands of the user may grasp the concave portion 22 and the protrusion portion 24 conveniently to rotate the handle 2. The concave portion 22 and the protrusion portion 24 provide the grasp to be comfortable. FIG. 2 shows that when only one hand grasps the handle 2, the palm of the hand holds the protrusion portion 24 and the fingers are pressed on an inclined surface 23 defined in a peripheral edge of the handle 2. This is also a comfortable grasp.

While we have shown and described the embodiment in accordance with the present invention, it should be clear to those skilled in the art that further embodiments may be made without departing from the scope of the present invention.

What is claimed is:

1. A wrench 1 comprising:
a function end and a handle connected to the function end, the handle having a concave first side and two curvatures defined in a second side of the handle, the two curvatures having opposite slopes.

2. The wrench as claimed in claim 1, wherein the function includes a fixed jaw and a movable jaw, the fixed jaw including a clamping surface which extends from the function end and a rounded root portion connected between the clamping surface and the function end.

3. The wrench as claimed in claim 1, wherein the movable jaw has a clamping surface which has a rounded edge which faces the rounded root portion of the fixed jaw.

4. The wrench as claimed in claim 1 further comprising an inclined surface defined in a peripheral edge of the handle.
